(19) United States
(12) Patent Application Publication
(10) Pub. No.: US 2026/0187517 A1
(43) Pub. Date: Jul. 2, 2026

(54) ASSESSMENT OF QUANTUM DEVICE QUALITY USING MANY-BODY LOCALIZATION

(71) Applicant: International Business Machines Corporation, Armonk, NY (US)

(72) Inventors: Paul Nation, Yorktown Heights, NY (US); Hwajung Kang, Yorktown Heights, NY (US)

(21) Appl. No.: 19/008,031

(22) Filed: Jan. 2, 2025

(51) Int. Cl. G06N 10/70; G06N 10/20; G06N 10/40

(52) U.S. Cl. CPC G06N 10/70; G06N 10/20; G06N 10/40

(57) ABSTRACT

Systems/techniques that assess quantum device quality using many-body localization are provided. In various embodiments, a system can comprise a memory that stores computer executable components and a processor that executes the computer executable components stored in the memory. In various embodiments, the computer executable components can comprise a characterization component that can characterize qubits of a quantum device. In various aspects, characterizing qubits of the quantum device can comprise executing, on the quantum device, quantum circuits with many-body localization (MBL) in parallel to cover a topology of the quantum device.

### BACKGROUND

The subject disclosure relates to quantum device characterization, and more specifically to assessing quantum device quality using many-body localization.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can assess quantum device quality using many-body localization are described.

According to one or more embodiments, a system is provided. In various aspects, the system can comprise a memory that stores computer executable components and a processor that executes the computer executable components stored in the memory. In various embodiments, the computer executable components can comprise a characterization component that can characterize qubits of a quantum device. In various aspects, characterizing qubits of the quantum device can comprise executing, on the quantum device, quantum circuits with many-body localization (MBL) in parallel to cover a topology of the quantum device.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates assessment of quantum device quality using many-body localization (MBL) in accordance with one or more embodiments described herein.

FIG. 2 illustrates another example, non-limiting system that facilitates assessment of quantum device quality using MBL in accordance with one or more embodiments described herein.

FIG. 3 illustrates an example, non-limiting circuit diagram of a quantum circuit with MBL over rows of a topology of a quantum device that facilitates assessment of quantum device quality using MBL in accordance with one or more embodiments described herein.

FIG. 4 illustrates an example, non-limiting circuit diagram of a quantum circuit with MBL over columns of a topology of a quantum device that facilitates assessment of quantum device quality using MBL in accordance with one or more embodiments described herein.

FIG. 5 illustrates an example, non-limiting graph of circuit execution data showing visible cycles of qubits of a quantum device in accordance with one or more embodiments described herein.

FIG. 6 illustrates example, non-limiting topology graphs of a quantum device before and after truncation based on execution of MBL quantum circuits in accordance with one or more embodiments described herein.

FIG. 7 illustrates example, non-limiting topology graphs of a quantum device before and after truncation based on execution of MBL quantum circuits in accordance with one or more embodiments described herein.

FIG. 8 illustrates an example, non-limiting block diagram showing obtaining of sub-graphs of a topology of a quantum device based on scores of qubits in accordance with one or more embodiments described herein.

FIG. 9 illustrates a flow diagram of an example, non-limiting computer-implemented method that facilitates assessment of quantum device quality using MBL in accordance with one or more embodiments described herein.

FIG. 10 illustrates a flow diagram of an example, non-limiting computer-implemented method that facilitates assessment of quantum device quality using MBL in accordance with one or more embodiments described herein.

FIG. 11 illustrates a flow diagram of an example, non-limiting computer-implemented method that facilitates assessment of quantum device quality using MBL in accordance with one or more embodiments described herein.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

According to one or more embodiments, a system is provided. In various aspects, the system can comprise a memory that stores computer executable components and a processor that executes the computer executable components stored in the memory. In various embodiments, the computer executable components can comprise a characterization component that can characterize qubits of a quantum device. In various aspects, characterizing qubits of the quantum device can comprise executing, on the quantum device, quantum circuits with many-body localization (MBL) in parallel to cover a topology of the quantum device. Such embodiments of the system can provide a number of advantages, including improving the accuracy of quantum device characterization with improved efficiency, enabling a more accurate quantum device characterization for mapping target quantum circuits for execution, and reducing the computation costs for quantum device characterization.

According to one or more embodiments of the aforementioned system, the computer executable components can further comprise a scoring component that determines scores of the qubits of the quantum device based on the characterizing of the quantum device. Such embodiments of the system can provide a number of advantages, including improving the accuracy of quantum device characterization by using more representative data for scoring qubits from execution of the quantum circuits with MBL.

According to one or more embodiments of the aforementioned system, the computer executable components can further comprise a truncation component that truncates the topology of the quantum device by removing one or more qubits or edges based on the scores of the qubits to obtain a truncated topology. Such embodiments of the system can provide a number of advantages, including improving the efficiency of determining optimal mappings for a target quantum circuit and improving execution results of the target quantum circuit by removing low-performing qubits.

According to one or more embodiments of the aforementioned system, the characterization component can execute the quantum circuits with MBL with readout error mitigation to produce circuit execution data, and can extract two-qubit error rates from the circuit execution data and an error model. According to one or more embodiments of the aforementioned system, the characterization component can extract the two-qubit error rates by solving an over-complete linear system of equations or fitting to an exponential decay. Such embodiments of the system can provide a number of advantages, including improving the accuracy of quantum device characterization with improved efficiency and enabling a more accurate quantum device characterization for mapping target quantum circuits for execution.

According to one or more embodiments of the aforementioned system, the computer executable components can further comprise a selection component that obtains one or more sub-graphs of the truncated topology that are isomorphic to a target quantum circuit. Such embodiments of the system can provide a number of advantages, including improving the efficiency of determining mappings for executing a target quantum circuit.

According to one or more embodiments of the aforementioned system, the scoring component can score the one or more sub-graphs based on the characterizing of the quantum device or calibration data of the quantum device. Such embodiments of the system can provide a number of advantages, including improving execution results of the target quantum circuit by using more representative data for scoring sub-graphs from execution of the quantum circuits with MBL.

According to one or more embodiments of the aforementioned system, the characterization component can iteratively execute the quantum circuits on the quantum device until a termination criterion is satisfied for the qubits of the quantum device. Such embodiments of the system can provide a number of advantages, including reducing computational costs and time to characterize a quantum device.

According to one or more embodiments of the aforementioned system, the characterization component can extract the circuit execution data based on a number of visible cycles per qubit or a decay rate. Such embodiments of the system can provide a number of advantages, including enabling the use of more representative data for characterizing a quantum device.

According to one or more embodiments of the aforementioned system, the characterization component can determine the number of visible cycles by measuring magnetizations of the qubits as a function of a number of cycles. Such embodiments of the system can provide a number of advantages, including enabling the use of more representative data for characterizing a quantum device.

According to one or more embodiments of the aforementioned system, the characterization component can evaluate the number of cycles at each execution iteration, and can perform a next execution iteration until a defined fraction of the quantum device is characterized. Such embodiments of the system can provide a number of advantages, including reducing computational costs and time to characterize a quantum device.

In various aspects, the above-described system can be reformulated, reformatted, or otherwise implemented as a computer-implemented method or as a computer program product.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A quantum device can be any suitable device that utilizes a qubit lattice (e.g., a plurality of superconducting qubits fabricated on one or more quantum substrates and exhibiting any suitable connection topology) for information processing. Quantum computing holds significant promise for solving problems beyond the reach of classical computers, but current quantum devices are imperfect and highly susceptible to noise. Quantum devices, such as superconducting quantum devices, exhibit variability in key device performance metrics (e.g., two-qubit errors, readout errors, T1 times, T2 times) across different chips and operations. Such variability can present challenges when utilizing a quantum device, especially when using a non-negligible fraction of the total qubits within the quantum device. Particularly, this variability directly impacts the ability to implement quantum algorithms or quantum operations reliably.

To perform quantum algorithms or quantum computations effectively and reliably on a quantum device (e.g., to optimize fidelity of circuit output), it is crucial to characterize the quantum device to identify an optimal set of qubits with the quantum device on which to execute a quantum circuit. Quantum device characterization is the process of measuring and evaluating performance metrics of a quantum device to identify its operational properties, variability, and limitations. Variability in qubit performance, such as gate errors, noise levels, and energy lifetimes, can significantly degrade computational accuracy if not accounted for. By thoroughly characterizing the quantum device, it becomes possible to select low-error qubits and optimize their arrangement to align with the requirements of a given quantum circuit. This step is critical for mitigating the effects of noise and variability, ultimately enhancing the reliability and performance of quantum computations.

Some existing techniques facilitate quantum device characterization for execution of a target quantum circuit using calibration data. Specifically, such existing techniques map a target quantum circuit for execution to the topology of a quantum device on which the target quantum circuit is to be executed based on pre-existing calibration data. The calibration data is used to score different sub-graphs of the topology of the quantum device to determine an optimal mapping of the target quantum circuit to the topology of the quantum device. These existing techniques provide a reasonable baseline for identifying good qubits and optimizing circuit execution. However, such existing techniques suffer from various disadvantages.

In particular, the calibration data relied upon by such existing techniques may not reflect the current state of the quantum device at the time of executing the target quantum circuit. In other words, the calibration data can be outdated. At times, the calibration data can be up to 24 hours old. However, quantum devices, particularly superconducting systems, exhibit performance fluctuations on much shorter timescales (e.g., often faster than 24 hours). As a result, the calibration data may no longer accurately represent the current state of the device at the time of circuit execution, leading to suboptimal qubit selection or configurations and thus causing degraded circuit fidelity. More specifically, outdated calibration data used by these existing techniques can lead to unreliable scoring of the quantum circuit mappings to the quantum device topology, causing suboptimal qubit selection or configurations. In some cases, reliance on such calibration data by these existing methods may even yield worse results than performing no characterization at all, as it fails to capture real-time changes in quantum device performance.

Consequently, this mismatch between outdated calibration data and the real-time state of the quantum device often necessitates executing actual quantum circuits to achieve higher accuracy in characterization of the quantum device. By running quantum circuits directly on the quantum device, it becomes possible to better capture its current noise and performance. However, this approach can be time-consuming and costly, as it requires running multiple test circuits, which consumes valuable quantum processing time and increases the overall cost of device usage. Additionally, the process of collecting sufficient calibration data to accurately characterize the device may require numerous iterations, further extending the time and resources needed before the target quantum circuit can be executed.

The various techniques described herein can help to address or ameliorate various of the above-described technical problems that plague existing techniques for facilitating quantum device characterization for execution of a target quantum circuit. In particular, the various techniques described herein can leverage quantum circuits with many-body localization (MBL) to introduce additional data to more reliably score mappings of a target quantum circuit to the topology of a quantum device so as to help solve such technical problems.

Specifically, various embodiments described herein can involve executing quantum circuits with MBL over the quantum device to extract two-qubit error rates from circuit execution data, which can be used to score qubits of the quantum device.

MLB is a phenomenon where interacting particles in a disordered system fail to reach thermal equilibrium, preventing the system from exhibiting typical statistical behaviors associated with thermalization. A quantum circuit with MBL refers to a quantum system in which qubits or quantum states interact in a disordered environment, leading to the phenomenon of many-body localization. In this context, the quantum circuit operates under conditions where, due to disorder and interactions among the qubits, the system fails to reach thermal equilibrium. The qubits remain localized, and the quantum information does not spread throughout the system as it typically would in a thermalized system. The properties of quantum circuits with MBL are special because, when these circuits are run, they act as “noise barometers” for the system. This means that quantum circuits with MBL can effectively measure and reflect the noise present in the system, specifically noise that is local to each qubit. As a quantum circuit with MBL operates, it interacts with the noise in the system, and the behavior of the circuit becomes sensitive to the local noise affecting each qubit. Thus, the quantum circuits with MBL are able to effectively sample the noise at the level of individual qubits, providing a way to detect and characterize localized disturbances or errors in the quantum device. Specifically, these quantum circuits with MBL can reveal how individual qubits of the quantum device are influenced by factors such as local error rates (e.g., noise or decoherence rates specific to each qubit, which can vary across the quantum device), spatial variation in noise (e.g., the distribution of noise across the quantum chip), qubit correlations (e.g., the relationship between qubits and how local noise can affect their interactions, coherence, or entanglement), or coherence times (e.g., how long individual qubits maintain quantum coherence under specific noise conditions).

Thus, by executing quantum circuits with MLB in parallel to cover the topology of the quantum device, noise in the quantum device can be seen at a per qubit level across the entire quantum device, which is not possible from executing general quantum circuits. This can enable a more reliable and cost-effective approach to characterizing an entire quantum device. Specifically, quantum circuits with MBL can be less time-consuming and more cost-effective for characterizing a quantum device than general quantum circuits due to their enhanced stability, reduced sensitivity to noise propagation, and lower demand for error correction resources.

Further, executing the quantum circuits with MLB and error mitigation can produce circuit execution data from which two-qubit error rates can be extracted. Such two-qubit error rates can then be used to more reliably score mappings of a target quantum circuit to the topology of the quantum device. That is, two-qubit error rates play a critical role in determining optimal mappings of quantum circuits to a quantum device's topology, as it directly impacts the fidelity of gate operations between qubits. When mapping a target quantum circuit to a quantum device, it's important to consider the connectivity and error rates between qubits, especially for operations requiring two-qubit gates.

For example, by knowing such two-qubit error rates between different qubits, pairs of qubits with lower error rates for operations that require entanglement or other two-qubit gates can be selected, reducing the likelihood of introducing errors during computation and leading to higher fidelity in the circuit's execution. As another example, since not all qubits are directly connected to each other in a quantum device, knowing such two-qubit error rates can help identify qubits that are directly connected with lower error rates, guiding the mapping of the target quantum circuit in a way that minimizes the need for costly swaps or additional gates to connect non-adjacent qubits. As yet another example, if two-qubit error rates vary across the device, the circuit mapping can be dynamically adjusted to account for the localized noise, ensuring that the most critical parts of the target quantum circuit are executed on qubits with the best available error performance, improving overall circuit reliability.

In any case, by enabling determination of two-qubit error rates, mappings of the target quantum circuit to the topology of the quantum device can be more reliably scored for determining an optimal mapping of the target quantum circuit. Thus, various embodiments described herein can more reliably and effectively characterize a quantum device and map a target circuit to the quantum device than existing techniques that instead rely on outdated calibration data to map a target circuit to the quantum device. Accordingly, various embodiments described herein can be considered as concrete technical improvements in quantum circuit transpilation.

Various embodiments described herein can be considered as a computerized tool (e.g., any suitable combination of computer-executable hardware or computer-executable software) that can assess quantum device quality using many-body localization. In various aspects, such a computerized tool can comprise an access component, an execution component, a scoring component, a truncation component, or a selection component.

In various embodiments, there can be a quantum device. In various aspects, the quantum device can comprise any suitable number of qubits. In various instances, such qubits can exhibit any suitable structures, constructions, or architectures (e.g., can be superconducting qubits, spin qubits, or quantum dots). In various cases, the qubits of the quantum device can be arranged or connected according to any suitable coupling topology.

In various embodiments, there can be a target quantum circuit. In various aspects, the target quantum circuit can be any suitable circuit of any suitable depth that is configured to operate on the qubits of the quantum device.

In various embodiments, there can be one or more MBL quantum circuits. In various aspects, each of the one or more MBL quantum circuits can be any suitable quantum circuit that exhibits MBL properties (e.g., wherein qubits within the circuit are localized and interact minimally with each other).

In various aspects, it can be desirable to characterize the quantum device for identifying optimal qubits of the quantum device for executing the target quantum circuit. As described herein, the computerized tool can facilitate such characterization and identification using the one or more MBL quantum circuits.

In various embodiments, the access component of the computerized tool can electronically access, via any suitable wired or wireless electronic connections, the quantum device, the target quantum circuit, or the one or more quantum circuits with MBL. In various instances, the access component can further access or otherwise receive, retrieve, or import from any suitable source the target quantum circuit or the one or more quantum circuits with MBL. For example, the access component can obtain the target quantum circuit or the one or more quantum circuits with MBL from any suitable centralized or decentralized data structure (e.g., graph data structure, relational data structure, hybrid data structure), whether remote from or local to the access component. In any case, the access component can access the quantum device, the target quantum circuit, or the one or more quantum circuits with MBL, such that other components of the computerized tool can electronically interact with (e.g., power-up, power-down, initialize, control) the quantum device or can electronically interact with (e.g., read, write, edit, copy, manipulate, execute) the target quantum circuit or the one or more quantum circuits with MBL.

In various embodiments, the execution component of the computerized tool can electronically command or instruct the quantum device to execute or otherwise perform the one or more quantum circuits with MBL (e.g., can initialize the qubits of the quantum device in any suitable fashion, can cause those initialized qubits to perform whatever sequence of quantum operations is called for by the one or more quantum circuits with MBL, and can cause whatever resultant quantum states are taken on by the qubits of the quantum device to be read or measured).

Such execution of the one or more MBL quantum circuits can produce circuit execution data that can include decay rates of the set of qubits 106 or measured magnetizations of the set of qubits 106 as a function of number of cycles executed.

In this way, two-qubit error rates can be extracted from the circuit execution data without excessive consumption of time and resources. Indeed, various embodiments described herein can be considered as executing quantum circuits with MBL to generate data for characterizing a quantum device that reflects the current state of the quantum device rather than characterizing a quantum device using outdated calibration data. Thus, the accuracy of the characterization of the quantum device can be improved, and subsequent obtaining of optimal mappings of a target quantum circuit to the quantum device can be more reliable and accurate. Additionally, the quantum circuits with MBL can be executed in parallel on the quantum device to cover its full topology. Thus, the execution time and computation resources required for characterizing the quantum device can be reduced.

In various embodiments, the scoring component of the computerized tool can score each of the qubits based on the circuit execution data. Specifically, the scores can be assigned based on the decay rate, the number of visible cycles, or the two-qubit error rate to the left and the right of each qubit.

In various embodiments, the truncation component of the computerized tool can truncate the topology of the quantum device based on the scores assigned by scoring component. In various aspects, the topology of the quantum device after truncation can be referred to as a truncated topology. In various aspects, the truncation component can truncate the topology by removing qubits or edges that connect the qubits from the topology. In this way, sub-graphs of the topology can be obtained more efficiently when determining an optimal subset of qubits for executing the target quantum circuit by removing qubits or possible sub-graphs that exhibit poor performances.

In various embodiments, the selection component of the computerized tool can obtain sub-graphs of the topology that are isomorphic to the target quantum circuit using any suitable method. Accordingly, in various embodiments, the scoring component can score the sub-graphs based on the characterization of the quantum device based on the executing of the one or more MBL quantum circuits (e.g., based on the scores assigned to each of the qubits). Thus, based on the scores of the sub-graphs, the optimal sub-graph can be selected for executing the target quantum circuit.

Various embodiments described herein can be employed to use hardware or software to solve problems that are highly technical in nature (e.g., to assess quantum device quality using many-body localization), that are not abstract and that cannot be performed as a set of mental acts by a human. Further, some of the processes performed can be performed by a specialized computer (e.g., quantum devices comprising tangible qubits that can execute or implement quantum circuits).

Neither the human mind nor a human with pen and paper can: electronically access a quantum circuit with MBL; electronically execute the quantum circuit with MBL on a quantum device so as to characterize the quantum device; score electronically select qubits to remove from a topology of the quantum device; or electronically select sub-graphs of the topology of the quantum device. After all, a quantum device is a specialized piece of computing hardware that utilizes physical qubits (e.g., superconducting qubits, such as transmons) to process information. Physical qubits cannot be implemented by the human mind or by a human with pen and paper. Moreover, a quantum circuit can be a sequence of quantum gates that can be executed on a quantum device. Neither the human mind, nor a human with pen and paper, can execute quantum gates on physical qubits. Also, the very field of quantum device characterization is focused on electronically executing quantum circuits to obtain data to characterize a quantum device so that a target quantum circuit can be mapped and executed on specific quantum hardware. It would make no sense whatsoever to discuss the field of quantum device characterization outside of a computing context. Therefore, a computerized tool that can assess quantum device quality using quantum circuits with MBL is inherently computerized and cannot be implemented in any sensible, practicable, or reasonable way without computers.

In various instances, one or more embodiments described herein can integrate the herein-described teachings into a practical application. As mentioned above, some existing techniques rely on calibration data to determine and select optimal subsets of qubits for executing a target quantum circuit. Unfortunately, such existing techniques can be unreliable due to the calibration data not accurately reflecting a current state of the quantum device. As also mentioned above, other existing techniques assess a quantum device by repeatedly executing quantum circuits to characterize the quantum device. Although such other existing techniques are able to achieve a more accurate characterization of the quantum device, such other existing techniques are time-consuming and computationally expensive to implement. As such, existing techniques suffer from various technical problems.

Accordingly, the various embodiments described herein can be considered as solving, addressing, or otherwise ameliorating the technical problems that afflict such existing techniques. In particular, various embodiments described herein can include leveraging quantum circuits with MBL to produce circuit execution data that more reliably represents the current state of the quantum device with reduced computation costs. Contrast this with existing techniques that instead rely on outdated and unreliable calibration data or require time-consuming and expensive execution of general quantum circuits to characterize a quantum device. Thus, by leveraging quantum circuits with MBL to produce circuit execution data that more reliably represents the current state of the quantum device, various embodiments described herein can facilitate quantum device characterization in less time or more accurately than existing techniques. For at least these reasons, various embodiments described herein constitute concrete and tangible technical improvements or technical effects in the field of quantum device characterization and thus certainly qualify as useful and practical applications of computers.

It should be appreciated that the figures and the herein disclosure describe non-limiting examples of various embodiments. It should further be appreciated that the figures are not necessarily drawn to scale.

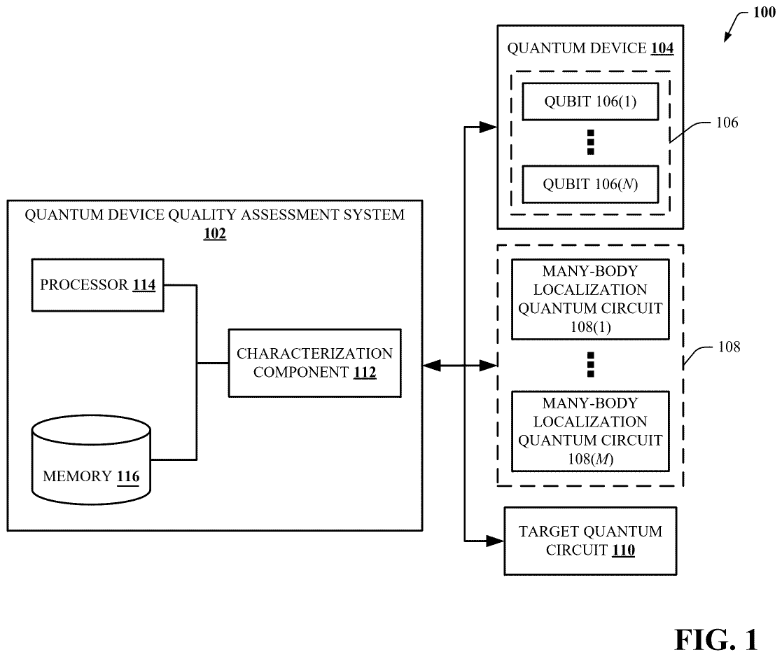

FIG. 1 illustrates a block diagram of an example, non-limiting system 100 that can assess quantum device quality using many-body localization in accordance with one or more embodiments described herein. As shown, a quantum device quality assessment system 102 can be electronically integrated, via any suitable wired or wireless electronic connections, with a quantum device 104, with one or more MBL quantum circuits 108, or with a target quantum circuit 110.

In various embodiments, the quantum device quality assessment system 102 can comprise a processor 114 (e.g., computer processing unit, microprocessor) and a non-transitory computer-readable memory 116 that is operably connected or coupled to the processor 114. The memory 116 can store computer-executable instructions which, upon execution by the processor 114, can cause the processor 114 or other components of the quantum device quality assessment system 102 (e.g., a characterization component 112, an access component 202, an execution component 204, a scoring component 206, a truncation component 208, and/or a selection component 210) to perform one or more acts. In various embodiments, the memory 116 can store computer-executable components (e.g., a characterization component 112, an access component 202, an execution component 204, a scoring component 206, a truncation component 208, and/or a selection component 210), and the processor 114 can execute the computer-executable components.

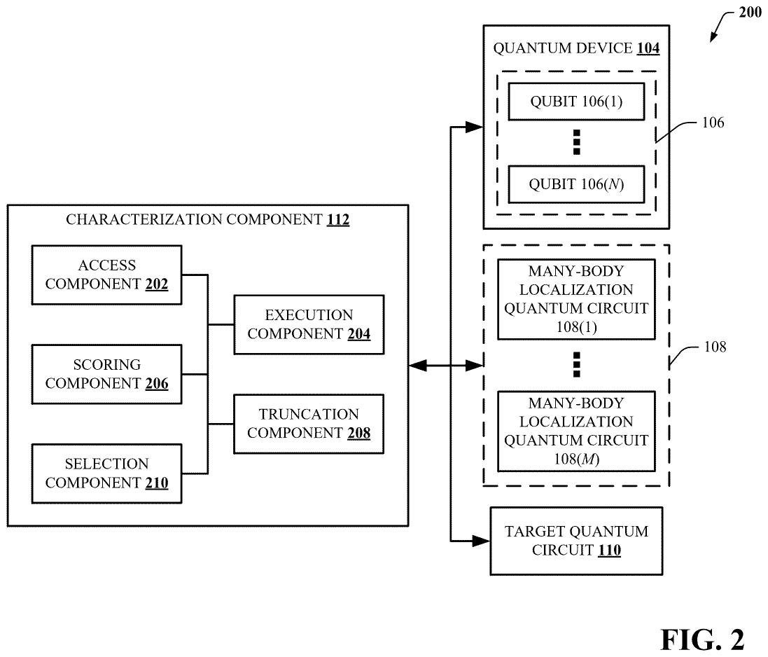

In various embodiments, characterization component 112 can comprise access component 202, execution component 204, scoring component 206, truncation component 208, and selection component 210 as illustrated in FIG. 2.

In various embodiments, the quantum device 104 can be any suitable quantum computing device or quantum computing hardware. In various aspects, the quantum device 104 can comprise or otherwise include a set of qubits 106. In various instances, the set of qubits 106 can have n qubits for any suitable positive integer n: a qubit 106(1) to a qubit 106(n). In various cases, any of the set of qubits 106 can exhibit any suitable structure or architecture. As a non-limiting example, any of such qubits can exhibit a superconducting qubit architecture (e.g., such qubit can be constructed from any suitable number of Josephson junctions shunted by any suitable number of planar capacitor pads). As another non-limiting example, any of such qubits can exhibit a quantum dot architecture. As yet another non-limiting example, any of such qubits can exhibit a spin qubit architecture. In various aspects, different qubits of the set of qubits 106 can exhibit the same or different structures or architectures as each other.

Although not explicitly shown in FIG. 1, the quantum device 104 can comprise or otherwise be associated with any suitable hardware or software (e.g., real-time controllers implemented in field programmable gate arrays of the quantum device 104) that can be used to initialize any of the set of qubits 106, or that can be used to perform any suitable quantum operations (e.g., quantum gates, qubit measurements, qubit idling) on the set of qubits 106.

In various embodiments, the one or more MBL quantum circuits 108 can comprise, have, or otherwise possess m MBL quantum circuits, for any suitable positive integer m>1: an MBL quantum circuit 108(1) to an MBL quantum circuit 108(m). In various aspects, each of the one or more MBL quantum circuits 108 can be any suitable quantum circuit that exhibits MBL (e.g., wherein qubits within the circuit are localized and interact minimally with each other).

As a non-limiting example, the one or more MBL quantum circuits 108 can be discrete time crystal (DTC) circuits. A DTC circuit is a quantum circuit that generates a discrete time-crystalline phase, characterized by a periodic oscillation of the quantum system's state in response to an external, discrete-time drive, without reaching thermal equilibrium. DTC circuits repeatedly apply a specific sequence of gates to create a stable, oscillating pattern in a quantum state that persists over time, defying the natural tendency toward decoherence or disorder.

No matter the type of MBL circuit used, an advantage of using one or more MBL quantum circuits 108 to characterize quantum device 104 is that they can be designed as linear chains, which can simplify the process of characterizing any of the set of qubits 106 in the quantum device 104. The linear arrangement of the one or more MBL quantum circuits 108 can allow for an efficient way to segment the set of qubits 106 of quantum device 104 into manageable units, enabling a quick and meaningful characterization of any of the set of qubits 106. In other words, by organizing the quantum device 104 into rows and columns, it can become easier to design circuits that isolate and measure the performance of any of the set of qubits 106 and their local environments. Thus, using one or more MBL quantum circuits 108 to characterize can significantly reduce the complexity of characterizing quantum device 104, particularly as the size of quantum device 104 increases, enabling more efficient and accurate characterization with less computational resources.

Note that, although the present disclosure mainly discusses the one or more MBL quantum circuits 108 as DTC circuits, the one or more MBL quantum circuits 108 are not limited to DTC circuits and can be any suitable type of MBL.

In various embodiments, the target quantum circuit 110 can be any suitable sequence of any suitable types of quantum gates (e.g., Pauli gates, Hadamard gates, Phase gates, entangling gates) that can be executed in parallel or in series on the set of qubits 106.

In various aspects, it can be desirable to characterize quantum device 104 for identifying optimal qubits of the set of qubits 106 for executing the target quantum circuit 110. As described herein, the quantum device quality assessment system 102 can facilitate such characterization and identification.

FIG. 2 illustrates another example, non-limiting system 200 that facilitates assessment of quantum device quality using MBL in accordance with one or more embodiments described herein.

In various aspects, the access component 202 can electronically access, in any suitable fashion, the quantum device 104, such that the quantum device quality assessment system 102 can electronically activate (e.g., power-up), electronically deactivate (e.g., power-down), or otherwise electronically control the quantum device 104. Furthermore, in various instances, the access component 202 can electronically receive, retrieve, obtain, import, or otherwise access, from any suitable data structures or from any suitable computing devices, the one or more MBL quantum circuits 108 or the target quantum circuit 110. In any case, the access component 202 can electronically access (e.g., send or receive data or program instructions to or from) the quantum device 104, the one or more MBL quantum circuits 108, or the target quantum circuit 110, such that other components of the quantum device quality assessment system 102 can electronically interact with the quantum device 104, with the one or more MBL quantum circuits 108, or with the target quantum circuit 110.

In various embodiments, the execution component 204 can instruct, command, or otherwise cause the one or more MBL quantum circuits 108 to be executed on, implemented on, or otherwise performed on the quantum device 104. Such execution of the one or more MBL quantum circuits 108 can produce circuit execution data. In various aspects, the circuit execution data can include a number of or a decay rate of any of the set of qubits 106. That is, the circuit execution data can be any suitable electronic data (e.g., can be one or more scalars, one or more vectors, one or more matrices, one or more tensors, one or more character strings, or any suitable combination thereof) that indicates the number of visible cycles for each of the set of qubits 106 and/or a decay rate of one or more of the set of qubits 106.

In various aspects, the execution component 204 can extract two-qubit error rates from the circuit execution data. To achieve this, the execution component 204 can execute the one or more MBL quantum circuits 108 with error mitigation under an assumed error model (e.g., noise model) to produce the circuit execution data. Thereafter, the execution component 204 can equate the number of visible cycles of a qubit to two-qubit error rates of the qubit. More specifically, the relationship between the number of visible cycles on an i^{th} qubit and the two-qubit error rates of the qubit can be defined using the following equation:

$${N}_{vis}^{i} ≃ \frac{15}{16} \frac{1}{{ϵ}_{i}^{left} + {ϵ}_{i}^{right}}$$

Note that, this is one possibility out of many possible noise models, and that any suitable noise model can be used.

Here,

$${N}_{vis}^{i}$$

denotes the number or visible cycles of the i^{th} qubit,

$${ϵ}_{i}^{left}$$

denotes the two-qubit error rate to the left of the i^{th} qubit, and

$${ϵ}_{i}^{right}$$

denotes the two-qubit error rate to the left of the i^{th} qubit.

In various aspects, the execution component 24 can assume any suitable error model. For example, the error model can be defined by user input.

In various aspects, the execution component 204 can obtain the two-qubit error rate to the left and the right of the qubit (e.g., between each neighboring qubit in the linear chain of qubits) due to the linear chain structure of the one or more MBL quantum circuits 108. Particularly, the execution component 204 can obtain the two-qubit error rates by solving an over-complete linear system of equations or fitting to an exponential decay.

Accordingly, in various aspects, the scoring component 206 can score each of the set of qubits 106 using the two-qubit error rates, and more specifically based on the two-qubit error rate to the left and to the right of each of the set of qubits 106 (e.g., higher scores indicate lower error-rates and lower scores indicate higher error-rates, higher scores indicate higher error-rates and lower scores indicate lower error-rates).

In various embodiments, the scoring component 206 can score each of the set of qubits 106 such that the score indicates the two-qubit error rate to the left and the right of each qubit using any suitable scoring scheme. As a non-limiting example, the score assigned to the i^{th} qubit can be a composite score that incorporates the two-qubit error rate to the left of the i^{th} qubit and the two-qubit error rate to the right of the i^{th} qubit, resulting in a single score. As another non-limiting example, the score assigned to the i^{th} qubit can comprise a first and a second sub-score that indicate the two-qubit error rate to the left of the i^{th} qubit and the two-qubit error rate to the right of the i^{th} qubit respectively.

In various embodiments, the truncation component 208 can truncate the topology of the quantum device 104 based on the scores assigned by scoring component 206. In various aspects, the topology of the quantum device 104 after truncation can be referred to as a truncated topology.

In various embodiments, the truncation component 208 can truncate the topology of the quantum device 104 based on the scores assigned to the set of qubits 106. That is, if any of the set of qubits 106 have a score that exceeds a defined threshold, the truncation component 208 can remove those qubits from consideration in later identifying an optimal subset of the set of qubits 106 for executing the target quantum circuit 110. In other words, if any of the set of qubits 106 exhibit poor performance that falls below the defined threshold, the truncation component 208 can remove those qubits from the topology of the quantum device 104, thus simplifying the search for optimal subsets of the set of qubits 106 for executing the target quantum circuit 110.

In various instances, the truncation component 208 can also truncate the topology of the quantum device 104 by removing edges of the topology of the quantum device 104. That is, in various aspects, the score of the qubit can indicate the two-qubit error rate in a direction of the qubit (e.g., the left or the right of the qubit).

In other words, the edges of the topology of the quantum device 104 can be scored (e.g., as a separate score, comprised by the score of the qubit, or/or otherwise indicated by the score of the qubit). For example, a left edge of the i^{th} qubit in the topology of quantum device 104 can be assigned a score based on the two-qubit error rate to the left of the i^{th} qubit

$$( e . g . , {ϵ}_{i}^{left} ) .$$

Further, a right edge of the i^{th} qubit in the topology of quantum device 104 can be assigned a score based on the two-qubit error rate to the right of the i^{th} qubit

$$( e . g . , {ϵ}_{i}^{right} ) .$$

Accordingly, the truncation component 208 can remove the edges of any of the set of qubits 106 that have a score below the defined threshold. For example, a qubit can exhibit poor performance that exceeds the defined threshold in the left direction but not in the right direction. As a result, the truncation component 208 can remove the left edge of the qubit so that the qubit and the right edge of the qubit remains in the truncated topology of quantum device 104.

In various aspects, given the target quantum circuit 110, the selection component 210 can obtain sub-graphs of the truncated topology of the quantum device 104 based on the scores of the set of qubits 106. In particular, the selection component 210 can obtain sub-graphs that are isomorphic to the target quantum circuit 110. A sub-graph that is isomorphic to the target quantum circuit 110 means that there is a one-to-one correspondence between the qubits and edges of the sub-graph and the qubits and qubit connectivity of the target quantum circuit 110.

By first removing qubits or edges from the topology of quantum device 104 that are low-performing (e.g., poor performance beyond a defined threshold), finding of the sub-graphs can be made faster, and thus scoring of the sub-graphs can be faster for determining the optimal sub-graph for the target quantum circuit 110. In other words, truncating the topology of quantum device 104 based on two-qubit error rates can make finding of the optimal sub-graph for mapping the target quantum circuit 110 to more efficient.

In various instances, the selection component 210 can utilize any suitable method to obtain the sub-graphs. In various cases, the selection component 210 can leverage or employ machine learning to intelligently learn which sub-graphs of the truncated topology of the quantum device 104 are isomorphic to the target quantum circuit 110. In any case, selection component 210 can obtain a set of sub-graphs of the truncated topology of the quantum device 104 that are isomorphic to the target quantum circuit 110.

Thereafter, in various aspects, the scoring component 206 can score each of the sub-graphs based on the two-qubit error rates of the qubits in the respective sub-graph (e.g., the scores of the qubits in the sub-graph). For example, if a first sub-graph contains more poor-performing qubits than a second sub-graph, the scoring component 206 can assign a lower score to the first sub-graph and a higher score to the second sub-graph. Similarly, if a first sub-graph contains more high-performing qubits than a second sub-graph, the scoring component 206 can assign a higher score to the first sub-graph and a lower score to the second sub-graph. In various cases, the scoring component 206 can score each of the sub-graphs based on an optimization of a cost function that includes the scores of the set of qubits 106. In various instances, the scoring component 206 can leverage or employ machine learning to intelligently score each of the sub-graphs. Further, the scoring component 206 can score each of the sub-graphs based on the characterization of the quantum device 104 (e.g., scores of the set of qubits 106) in addition to standard calibration data that is typically used. In other words, the scoring component 206 can use the characterization of the quantum device 104 in combination with standard calibration data to score each of the sub-graphs.

Accordingly, in various embodiments, the execution component 204 can execute the target quantum circuit 110 on quantum device 104 over the sub-graph with the highest score (e.g., the most optimal score). In other words, the execution component 204 can execute the target quantum circuit 110 on a subset of qubits of quantum device 104 that are in the sub-graph with the highest score. Thus, the target quantum circuit 110 can be executed using an optimal mapping that is representative of the current state of quantum device 104.

Note that, in various instances, the access component 202, the execution component 204, the scoring component 206, the truncation component 208, and the selection component 210 can collectively be considered as being characterization component 112 of the quantum device quality assessment system 102. In various aspects, it should be appreciated that characterization component 112 is described primarily herein as comprising five components (e.g., the access component 202, the execution component 204, the scoring component 206, the truncation component 208, and the selection component 210) for ease of explanation and illustration. However, the characterization component 112 is not limited to being implemented as exactly such five components in every embodiment. Indeed, in some embodiments, the functionalities described herein of such five components can be combined in any suitable fashions, so as to be implemented in or by fewer than five components (e.g., in some cases, a single component can perform all of the functionalities that are described herein with respect to the access component 202, the execution component 204, the scoring component 206, the truncation component 208, and the selection component 210). In other embodiments, the functionalities described herein of such five components can instead be distributed, separated, split, or fragmented in any suitable fashions, so as to be implemented in or by more than five components (e.g., two or more components can facilitate the functionalities that are performable by the access component 202; two or more components can facilitate the functionalities that are performable by the execution component 204; two or more components can facilitate the functionalities that are performable by the scoring component 206; two or more components can facilitate the functionalities that are performable by the s truncation component 208; two or more components can facilitate the functionalities that are performable by the selection component 210).

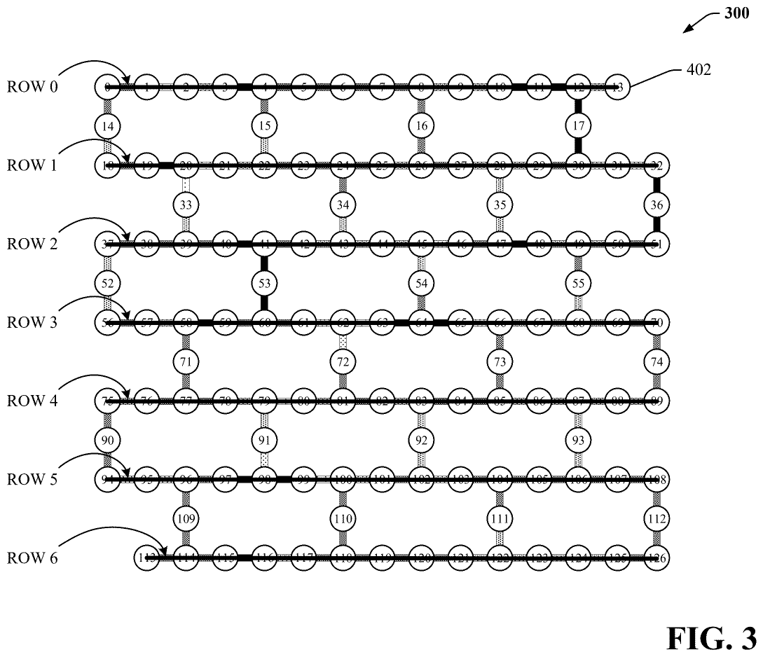

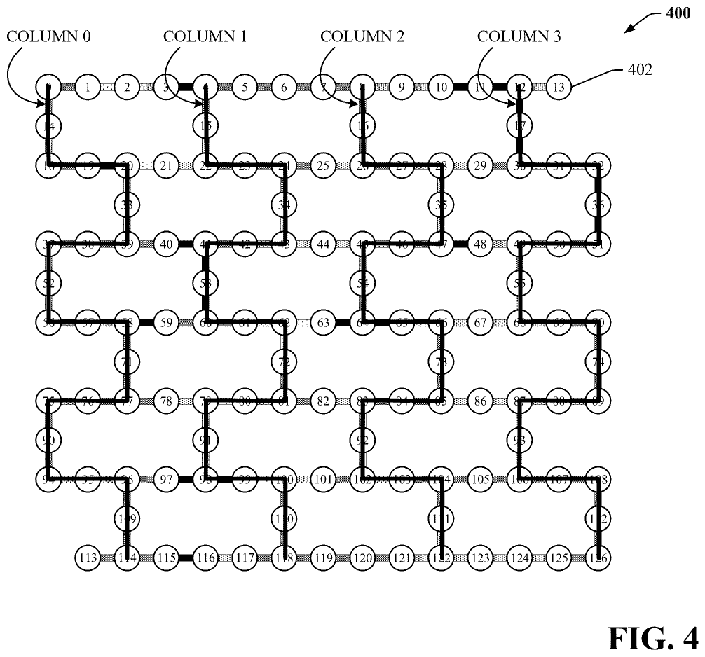

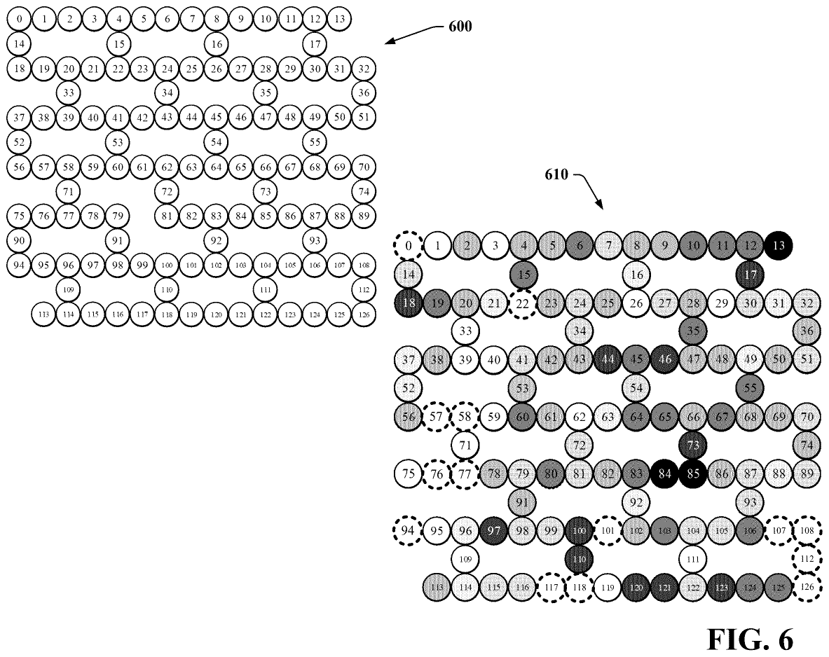

FIGS. 3 and 4 illustrate example, non-limiting circuit diagrams 300 and 400 of quantum circuits with MBL over the topology of quantum device 104. As previously stated elsewhere, the one or more MBL quantum circuits 108 can be executed in parallel to cover an entire topology 402 of quantum device 104. As a non-limiting example, in the case of using DTC circuits as the one or more MBL quantum circuits 108, the one or more MBL quantum circuits 108 can be linear chains. In other words, the one or more MBL quantum circuits 108 can exhibit linear arrangements. Such linear chains of the one or more MBL quantum circuits 108 can be depicted by non-limiting circuit diagrams 300 and 400. In the non-limiting examples of FIGS. 3 and 4, two quantum circuits with MBL can be used to cover topology 402 of quantum device 104 in entirety. Further, in the non-limiting examples of FIGS. 3 and 4 (and FIGS. 6-8), the quantum device 104 comprises 127 qubits which are denoted by integers from 0 to 126.

Turning to FIG. 3, the first quantum circuit with MBL, shown by non-limiting circuit diagram 300, can cover rows of the topology 402. For example, the topology 402 of quantum device 104 can consist of seven rows, which are labelled sequentially from “Row 0” to “Row 6”. Accordingly, since the topology 402 of quantum device 104 consists of seven rows, the first quantum circuit with MBL can comprise seven linear chains, each of which cover one of the seven rows of the topology 402. That is, each of the seven linear chains can be used to characterize a subset of the set of qubits 106 in parallel.

Turning to FIG. 4, the second quantum circuit with MBL, shown by non-limiting circuit diagram 400, can cover columns of the topology 402. For example, the topology 402 of quantum device 104 can consist of four columns, which are labelled sequentially from “Column 0” to “Column 3”. Accordingly, since the topology 402 of quantum device 104 consists of four columns, the first quantum circuit with MBL can comprise four linear chains, each of which cover one of the four columns of the topology 402. That is, each of the four linear chains can be used to characterize a subset of the set of qubits 106 in parallel. Further, in various embodiments, execution component 204 can execute the first quantum circuit with MBL and the second quantum circuit with MBL in parallel. This way, when executed in parallel, the topology 402 of quantum device 104 can be covered in entirety (e.g., all qubits in topology 402 are covered by the first and second quantum circuits with MBL). In other words, when executed in parallel, each row and column of the in topology 402 are covered by the first and second quantum circuits with MBL.

In various embodiments, each of the linear chains of the one or more MBL quantum circuits 108 can be separate. That is, each of the one or more MBL quantum circuits 108 can consist of distinct, non-interacting chains of qubits, where each chain operates independently within the overall quantum circuit. Thus, in various aspects, each of the linear chains of the one or more MBL quantum circuits 108 can be used to characterize a subset of the set of qubits 106 in parallel.

Note that, this is a non-limiting example and that the quantum device 104 can comprise a different topology than topology 402 depicted in FIGS. 3 and 4. Accordingly, although two quantum circuits with MBL having linear arrangements are used herein, any suitable number of quantum circuits with MBL having any suitable arrangement (or structure) can be used to cover the topology of the quantum device 104. Additionally, there can exist different combinations, numbers, and/or structures of the one or more MBL quantum circuits 108 that can be used to cover the topology of the quantum device 104.

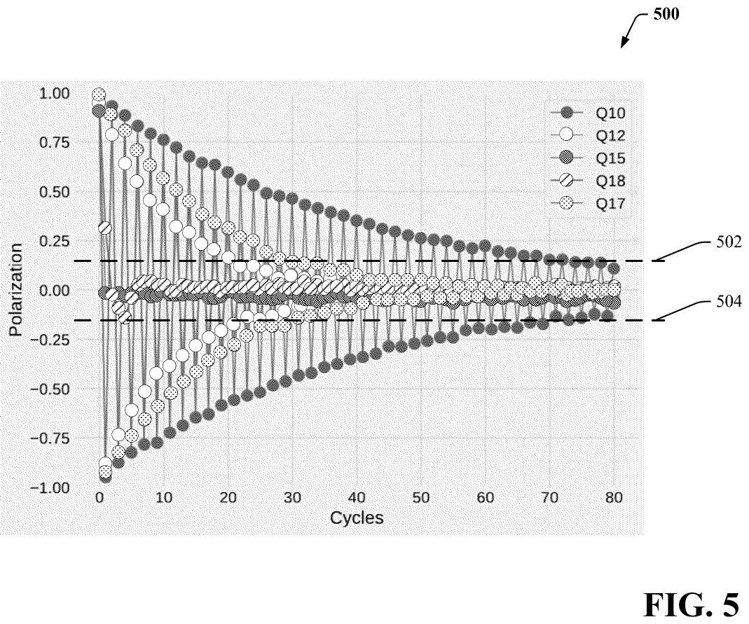

FIG. 5 illustrates an example, non-limiting graph 500 of circuit execution data showing visible cycles of qubits of a quantum device in accordance with one or more embodiments described herein.

The non-limiting graph 500 shows example circuit execution data that results from executing the one or more MBL quantum circuits 108. The x-axis of non-limiting graph 500 represents the number of cycles performed when executing the one or more MBL quantum circuits 108. The y-axis of non-limiting graph 500 represents the polarization (e.g., magnetization) of qubits. In various aspects, the number of visible cycles of any of the set of qubits 106 can be determined from measuring the magnetization of each qubit as a function of the number of cycles, as illustrated in non-limiting graph 500.

As an example, the non-limiting graph 500 shows the circuit execution data for a qubit chain which comprises five qubits that are denoted by Q10, Q12, Q15, Q18, and Q17. Ideally during execution, the polarization of a qubit should oscillate between −1 and 1. However, realistically, due to the noise present in the quantum device, qubits experience exponential decay toward the zero state. This means that the polarization of the qubit approaches 0. The exponential decay a qubit experiences can cause inaccurate quantum calculations or operations. Thus, it can be desirable to avoid using qubits that have a faster exponential decay for executing the target quantum circuit 110. In other words, it can be desirable to use qubits that exhibit more visible cycles (e.g., cycles where polarization of the qubit is within a desired range).

In various embodiments, the execution component 204 can determine the number of visible cycles for each of the five qubits based on a defined threshold. Specifically, the defined threshold can have an upper threshold 502 and a lower threshold 504. In various aspects, the upper threshold 502 and the lower threshold 504 can be defined based on user input. Accordingly, the execution component 204 can define the number of visible cycles of a qubit to be the number of cycles performed before the polarization of the qubit exceeds the upper threshold 502 or the lower threshold 504.

For instance, as shown in non-limiting graph 500, the upper threshold 502 can be a polarization of 0.15 and the lower threshold 504 can be a polarization of −0.15. Thus, the number of visible cycles of a qubit can be defined as the number of cycles performed before the polarization of the qubit falls within the range of −0.15 to 0.15. For example, Q10 has approximately 60 visible cycles before exhibiting a polarization within the range of −0.15 to 0.15. As more examples, Q12 has approximately 20 visible cycles, Q15 has 1 visible cycle, Q18 has 1 visible cycle, and Q17 has approximately 30 visible cycles.

In various aspects, qubits that exhibit a higher number of visible cycles can be considered higher-performing qubits. Conversely, qubits that exhibit a lower number of visible cycles can be considered lower-performing qubits. For example, Q10 exhibits the most visible cycles in the qubit chain and can thus be considered a higher-performing qubit, while Q15 and Q18 exhibit the least visible cycles, and can thus be considered lower-performing qubits.

In various embodiments, the execution component 204 can consider a maximum number of cycles to perform to ensure efficiency. In various cases, the maximum number of cycles can be defined based on user input. Furthermore, the execution component 204 can iteratively evaluate the maximum number of cycles until the quantum device 104 is fully characterized (e.g., all of the set of qubits 106 are characterized). That is, the execution component 204 can, after each cycle (or after every certain number of cycles), increase the maximum number of cycles if the maximum number of cycles has been reached but the entirety of quantum device 104 is not characterized. In some cases, the execution component 204 can iteratively evaluate and/or the maximum number of cycles until a fraction of the quantum device 104 is characterized. In various aspects, the fraction of the quantum device 104 to be characterized can be defined based on user input.

In various instances, the decay rate of the qubit can also be used to determine which qubits are better or worse performing. That is, scoring component 206 can score the set of qubits 106 based on the decay rate of the qubits. For example, qubits with faster decay rates can be assigned lower scores (e.g., such as Q15 and Q18) while qubits with slower decay rates can be assigned higher scores (e.g., such as Q10). In some cases, the decay rate and the number of visible cycles can be used in combination to determine which qubits are better or worse performing.

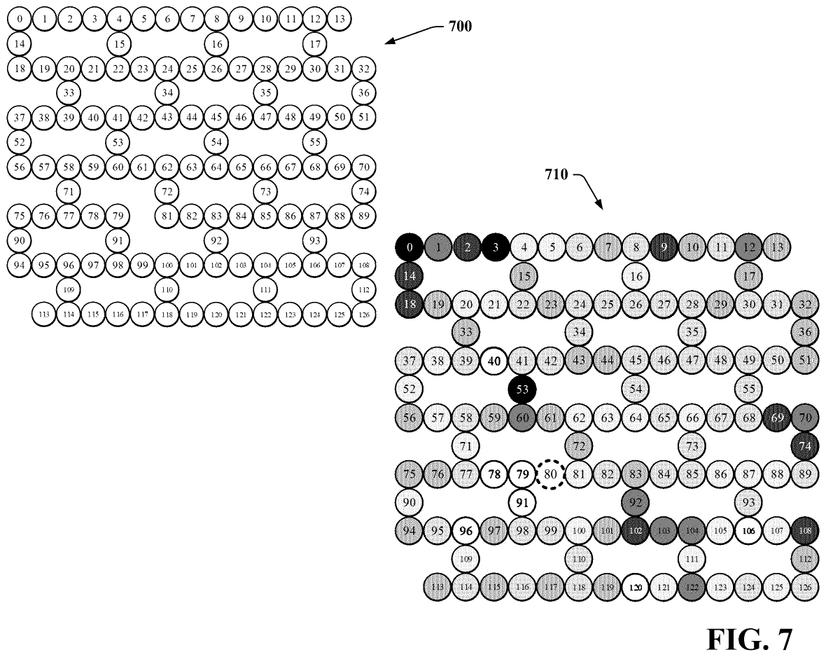

FIGS. 6 and 7 illustrate non-limiting examples of truncating a topology of quantum device 104 using the scores assigned to the set of qubits 106 based on the characterization of the quantum device 104. In FIGS. 6 and 7, the scores of each qubit are represented by the shading of the qubit in the topology graphs. That is, a darker shade of a qubit indicates a higher score (e.g., a higher-performing qubit) and a lighter shaded qubit indicates a lower score (e.g., a lower-performing qubit).

Turning to FIG. 6, a non-limiting topology graph 600 illustrates an example topology of quantum device 104. In this non-limiting example, the quantum device 104 can comprise 127 qubits which are denoted by integers from 0 to 126. In various embodiments, the scoring component 206 can assign scores to the 127 qubits based on the two-qubit error rates determined from the number of visible cycles per qubit. Accordingly, truncation component 208 can remove qubits or edges from the non-limiting topology graph 600 based on such scores, resulting in a non-limiting truncated topology graph 610. That is, one or more qubits can have a score that exceeds a defined threshold (e.g., falls below a defined minimum performance). In various aspects, the truncation component 208 can remove those one or more qubits (or left or right edges of those one or more qubits) from non-limiting topology graph 600. Such qubits that have been removed are depicted with a dotted outline.

For example, qubits 0, 22, 57, 58, 76, 77, 94, 101, 107, 108, 112, 117, 118, and 126 of the quantum device 104 can be assigned scores that exceed the defined threshold. Accordingly, truncation component 208 can remove those qubits from the non-limiting topology graph 600, resulting in the non-limiting truncated topology graph 610.

Turning to FIG. 7, a non-limiting topology graph 700 illustrates an example topology of quantum device 104. In this non-limiting example, the quantum device 104 can comprise 127 qubits which are denoted by integers from 0 to 126. In various embodiments, the scoring component 206 can assign scores to the 127 qubits based on the two-qubit error rates determined from the number of visible cycles per qubit. Accordingly, truncation component 208 can remove qubits or edges from the non-limiting topology graph 700 based on such scores, resulting in a non-limiting truncated topology graph 710. That is, one or more qubits can have a score that exceeds a defined threshold (e.g., falls below a defined minimum performance). In various aspects, the truncation component 208 can remove those one or more qubits (or left or right edges of those one or more qubits) from non-limiting topology graph 700. Such qubits that have been removed are depicted with a dotted outline.

For example, qubit 80 of the quantum device 104 can be assigned a score that exceeds the defined threshold. Accordingly, truncation component 208 can remove qubit 80 from the non-limiting topology graph 700, resulting in the non-limiting truncated topology graph 710.

Based on the characterization and scoring of qubits of the quantum device 104 in the non-limiting examples of FIGS. 6 and 7, it can be seen that the quantum device 104 of the non-limiting example of FIG. 7 is better performing than that of FIG. 6. More specifically, that of FIG. 7 only removes one qubit while that of FIG. 6 removes 14 qubits, indicating that the quantum device 104 of the non-limiting example in FIG. 7 may be better suited for executing target quantum circuit 110.

Although not depicted in FIG. 6 or 7, truncation component 208 can remove edges of the qubits. For example, if qubit 81 exhibits a low two-qubit error rate with qubit 72 and qubit 82 but a high two-qubit error rate with qubit 80, truncation component 208 can remove the edge that connects qubit 81 and qubit 80, leaving qubit 81 and the edges connecting qubit 72 and qubit 82 in the truncated topology.

In any case, by removing the qubits or edges from the topology of quantum device 104, obtaining sub-graphs of the truncated topology that are isomorphic to target quantum circuit 110 can be faster and more efficient.

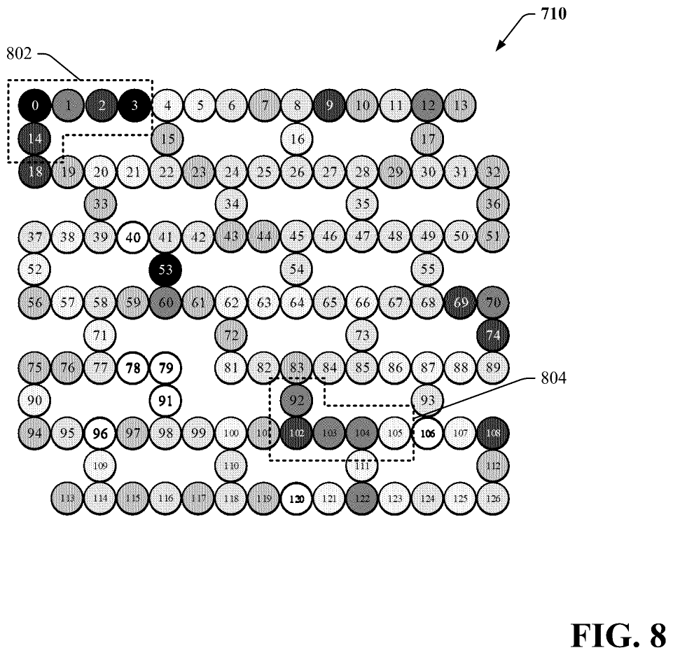

FIG. 8 illustrates an example, non-limiting block diagram 800 showing obtaining of sub-graphs of a topology of a quantum device based on scores of qubits in accordance with one or more embodiments described herein.

In various embodiments, given the target quantum circuit 110, the selection component 210 can obtain sub-graphs of the truncated topology of the quantum device 104. The sub-graphs can represent subsets of qubits of the quantum device 104 and connections that match the connectivity and operational requirements of target quantum circuit 110.

For example, the target quantum circuit 110 can require five qubits with nearest-neighbor connectivity. Accordingly, using non-limiting truncated topology graph 710, selection component 210 can find a sub-graph 802 and a sub-graph 804 that are isomorphic to target quantum circuit 110. For instance, selection component 210 can find linear sub-graphs (e.g., linear qubit chains) of non-limiting truncated topology graph 710, such as sub-graph 802 and sub-graph 804. As shown sub-graph 802 is a linear chain of qubits 0, 1, 2, 3, and 14. Further as shown sub-graph 804 is a linear chain of qubits 92, 102, 103, 104, and 105.

In various aspects, in response to obtaining the sub-graphs that are isomorphic to target quantum circuit 110, scoring component 206 can score each of the sub-graphs based on the characterization of the quantum device 104. Particularly, based on the scores of qubits in each sub-graph, scoring component 206 can assign a score to the sub-graph. For example, as shown, sub-graph 802 comprises a higher average of scores of qubits than sub-graph 804. In other words, sub-graph 802 contains more higher-performing qubits than sub-graph 804. Accordingly, scoring component 206 can assign a higher score to sub-graph 802 and a lower score to sub-graph 804.

In various aspects, scoring component 206 can utilize any suitable scoring scheme to score the sub-graphs so long as they indicate the performance of the qubits within each sub-graph. As a non-limiting example, scoring component 206 can use the average score of the qubits within a sub-graph to score the sub-graph. As a non-limiting example, scoring component 206 can use a weighted average of the qubits within a sub-graph to score the sub-graph.

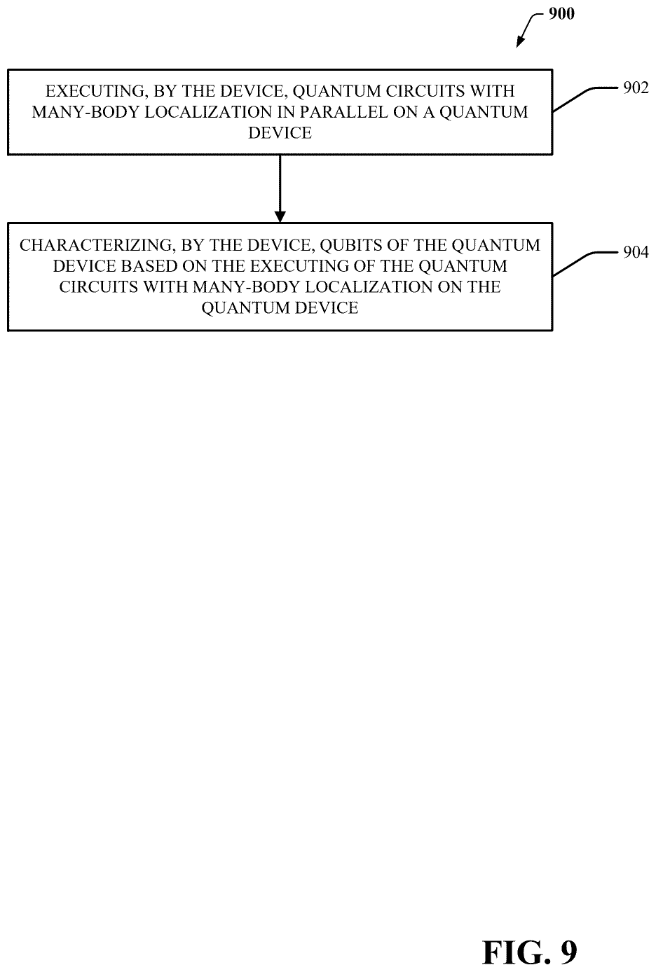

FIG. 9 illustrates a flow diagram of an example, non-limiting computer-implemented method 900 that can assess quantum device quality using many-body localization in accordance with one or more embodiments described herein. In various cases, the quantum device quality assessment system 102 can facilitate the computer-implemented method 900.

In various embodiments, act 902 can include executing, by a device (e.g., via 204) operatively coupled to a processor (e.g., 114), one or more quantum circuits with many-body localization (e.g., 108) in parallel on a quantum device (e.g., 104). As a non-limiting example, the quantum circuits with MBL can be DTC circuits that exhibit a linear arrangement and can be executed over rows or columns of the topology of the quantum device.

In various aspects, act 904 can include characterizing, by the device (e.g., via 120), qubits (e.g., 106) of the quantum device based on the executing of the quantum circuits with MBL on the quantum device.

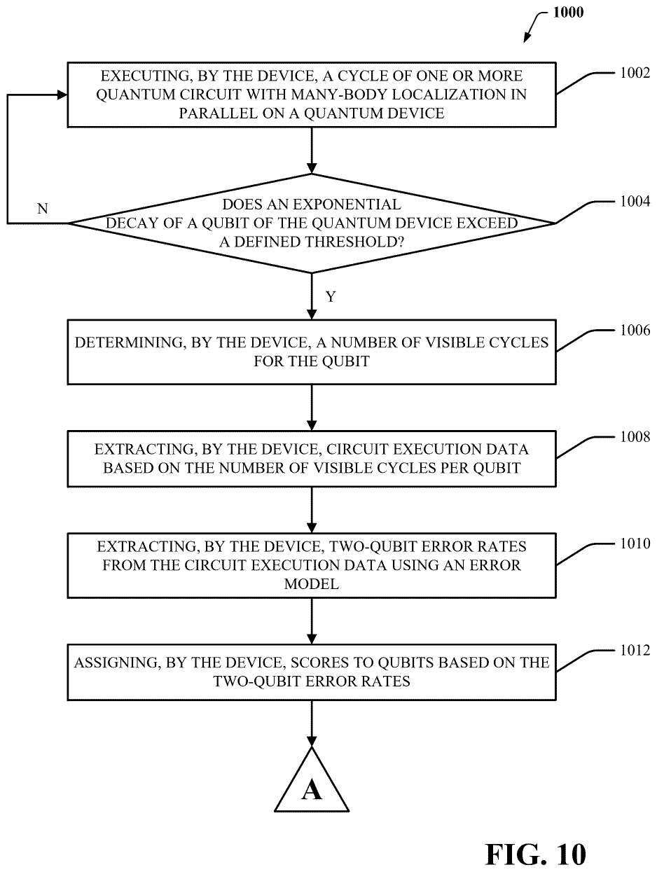

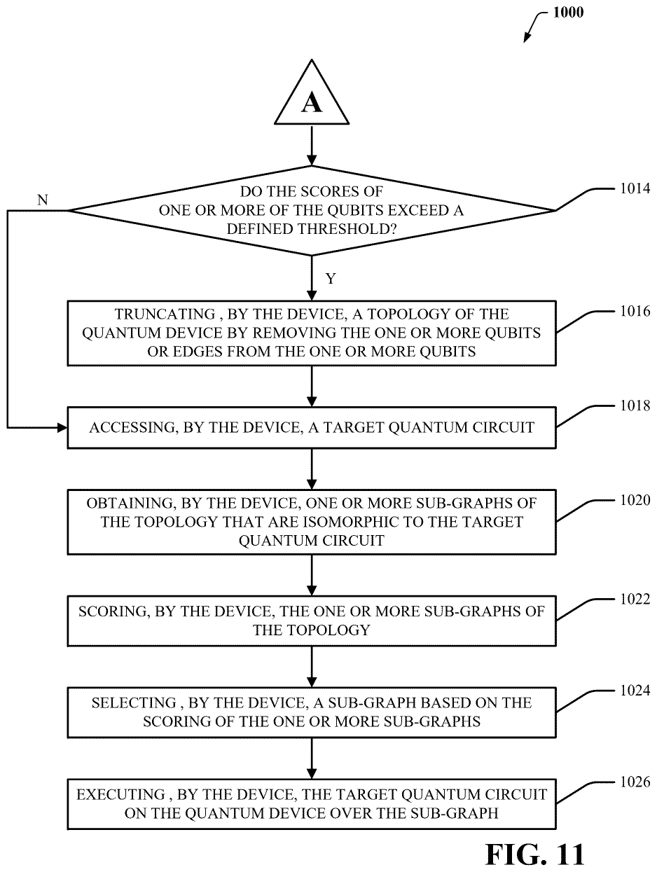

FIGS. 10 and 11 illustrate a flow diagram of an example, non-limiting computer-implemented method 1000 that can assess quantum device quality using many-body localization in accordance with one or more embodiments described herein. In various cases, the quantum device quality assessment system 102 can facilitate the computer-implemented method 1000.

In various embodiments, act 1002 can include executing, by a device (e.g., via 204) operatively coupled to a processor (e.g., 114), a cycle of one or more quantum circuits with MBL (e.g., 108) in parallel on a quantum device (e.g., 104).

In various aspects, act 1004 can include determining, by the device (e.g., via 204), whether an exponential decay of a qubit of the quantum device exceeds a defined threshold. If so, the computer-implemented method 1000 can proceed to act 1006. If not, the computer-implemented method 900 can proceed back to act 1002. In other words, computer-implemented method 1000 can include iteratively executing cycles of the one or more quantum circuits with MBL until the exponential decay of a qubit (or of a subset of qubits) of the quantum device exceeds a defined threshold.

In various instances, act 1006 can include determining, by the device (e.g., via 206), a number of visible cycles for the qubit (e.g., or for each of the subset of qubits).

In various cases, act 1008 can include extracting, by the device (e.g., via 206) circuit execution data based on the number of visible cycles per qubit (e.g., number of visible cycles for each qubit).

In various aspects, act 1010 can include extracting, by the device (e.g., via 206), two-qubit error rates from the circuit execution data using an error model (e.g., a noise model).

In various aspects, act 1012 can include assigning, by the device (e.g., via 206), scores to qubits based on the two-qubit error rates.

In various aspects, act 1014 can include determining, by the device (e.g., via 208), whether the scores of one or more of the qubits exceed a defined threshold. If so, the computer-implemented method 1000 can proceed to act 1016. If not, the computer-implemented method 900 can proceed to act 1018.

In various aspects, act 1016 can include truncating, by the device (e.g., via 208), a topology of the quantum device by removing the one or more qubits or edges from the one or more qubits.

In various aspects, act 1018 can include accessing, by the device (e.g., via 202), a target quantum circuit (e.g., 110).

In various aspects, act 1020 can include obtaining, by the device (e.g., via 210), one or more sub-graphs (e.g., 802, 804) of the topology that are isomorphic to the target quantum circuit.

In various aspects, act 1022 can include scoring, by the device (e.g., via 206), the one or more sub-graphs of the topology. In various aspects, the circuit execution data produced by executing the one or more quantum circuits with MBL can be used as additional information (e.g., in addition to calibration data) to score the one or more sub-graphs.

In various aspects, act 1024 can include selecting, by the device (e.g., via 210), a sub-graph based on the scoring of the one or more sub-graphs.

In various aspects, act 1026 can include executing, by the device (e.g., via 204), the target quantum circuit on the quantum device over the sub-graph.

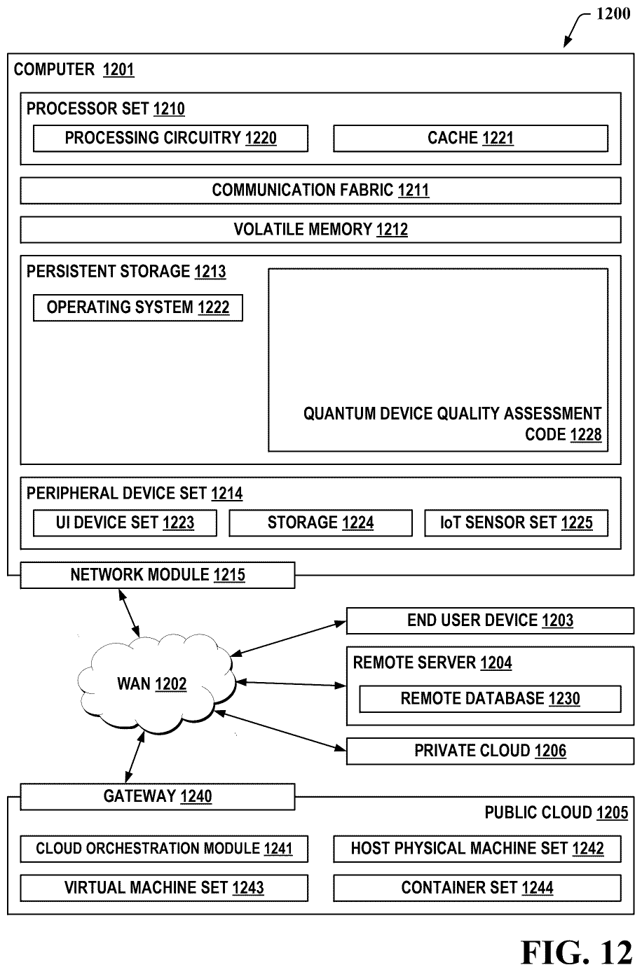

FIG. 12 and the following discussion are intended to provide a general description of a suitable computing environment 1200 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1200 contains an example of an environment for the execution of at least some of the computer code involved in performing the inventive methods, such as quantum device quality assessment code 1280. In addition to block 1280, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1280, as identified above), peripheral device set 1214 (including user interface (UI), device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 can take the form of a desktop computer, laptop computer, tablet computer, smart phone, smart watch or other wearable computer, mainframe computer, quantum device or any other form of computer or mobile device now known or to be developed in the future that is capable of running a program, accessing a network or querying a database, such as remote database 1230. As is well understood in the art of computer technology, and depending upon the technology, performance of a computer-implemented method can be distributed among multiple computers or between multiple locations. On the other hand, in this presentation of computing environment 1200, detailed discussion is focused on a single computer, specifically computer 1201, to keep the presentation as simple as possible. Computer 1201 can be located in a cloud, even though it is not shown in a cloud in FIG. 12. On the other hand, computer 1201 is not required to be in a cloud except to any extent as can be affirmatively indicated.

PROCESSOR SET 1210 includes one, or more, computer processors of any type now known or to be developed in the future. Processing circuitry 1220 can be distributed over multiple packages, for example, multiple, coordinated integrated circuit chips. Processing circuitry 1220 can implement multiple processor threads or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set can be located “off chip.” In some computing environments, processor set 1210 can be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods can be stored in block 1280 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1212 is any type of volatile memory now known or to be developed in the future. Examples include dynamic type random access memory (RAM) or static type RAM. Typically, the volatile memory is characterized by random access, but this is not required unless affirmatively indicated. In computer 1201, the volatile memory 1212 is located in a single package and is internal to computer 1201, but, alternatively or additionally, the volatile memory can be distributed over multiple packages or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 or directly to persistent storage 1213. Persistent storage 1213 can be a read only memory (ROM), but typically at least a portion of the persistent storage allows writing of data, deletion of data and re-writing of data. Some familiar forms of persistent storage include magnetic disks and solid-state storage devices. Operating system 1222 can take several forms, such as various known proprietary operating systems or open-source Portable Operating System Interface type operating systems that employ a kernel. The code included in block 1280 typically includes at least some of the computer code involved in performing the inventive methods.

PERIPHERAL DEVICE SET 1214 includes the set of peripheral devices of computer 1201. Data communication connections between the peripheral devices and the other components of computer 1201 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1223 can include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 can be persistent or volatile. In some embodiments, storage 1224 can take the form of a quantum computing storage device for storing data in the form of qubits. In embodiments where computer 1201 is required to have a large amount of storage (for example, where computer 1201 locally stores and manages a large database) then this storage can be provided by peripheral storage devices designed for storing large amounts of data, such as a storage area network (SAN) that is shared by multiple, geographically distributed computers. IoT sensor set 1225 is made up of sensors that can be used in Internet of Things applications. For example, one sensor can be a thermometer and another sensor can be a motion detector.

NETWORK MODULE 1215 is the collection of computer software, hardware, and firmware that allows computer 1201 to communicate with other computers through WAN 1202. Network module 1215 can include hardware, such as modems or Wi-Fi signal transceivers, software for packetizing or de-packetizing data for communication network transmission, or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201) and can take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 can be a client device, such as thin client, heavy client, mainframe computer or desktop computer.

REMOTE SERVER 1204 is any computer system that serves at least some data or functionality to computer 1201. Remote server 1204 can be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data can be provided to computer 1201 from remote database 1230 of remote server 1204.

PUBLIC CLOUD 1205 is any computer system available for use by multiple entities that provides on-demand availability of computer system resources or other computer capabilities, especially data storage (cloud storage) and computing power, without direct active management by the scale. The direct and active management of the computing resources of public cloud 1205 is performed by the computer hardware or software of cloud orchestration module 1241. The computing resources provided by public cloud 1205 are typically implemented by virtual computing environments that run on various computers making up the computers of host physical machine set 1242, which is the universe of physical computers in or available to public cloud 1205. The virtual computing environments (VCEs) typically take the form of virtual machines from virtual machine set 1243 or containers from container set 1244. It is understood that these VCEs can be stored as images and can be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware and firmware allowing public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1205 and private cloud 1206 are both part of a larger hybrid cloud.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a characterization component that characterizes qubits of a quantum device, wherein characterizing qubits of the quantum device comprises:
executing, on the quantum device, quantum circuits with many-body localization (MBL) in parallel to cover a topology of the quantum device.

2. The system of claim 1, further comprising:
a scoring component that determines scores of the qubits of the quantum device based on the characterizing of the quantum device.

3. The system of claim 2, further comprising:
a truncation component that truncates the topology of the quantum device by removing one or more qubits or edges based on the scores of the qubits to obtain a truncated topology.

4. The system of claim 1, wherein the characterization component executes the quantum circuits with MBL with readout error mitigation to produce circuit execution data, and extracts two-qubit error rates from the circuit execution data and an error model.

5. The system of claim 4, wherein the characterization component extracts the two-qubit error rates by solving an over-complete linear system of equations or fitting to an exponential decay.

6. The system of claim 3, further comprising:
a selection component that obtains one or more sub-graphs of the truncated topology that are isomorphic to a target quantum circuit.

7. The system of claim 6, wherein the scoring component scores the one or more sub-graphs based on the characterizing of the quantum device or calibration data of the quantum device.

8. The system of claim 1, wherein the characterization component iteratively executes the quantum circuits on the quantum device until a termination criterion is satisfied for the qubits of the quantum device.

9. The system of claim 4, wherein the characterization component extracts the circuit execution data based on a number of visible cycles per qubit or a decay rate.

10. The system of claim 9, wherein the characterization component determines the number of visible cycles by measuring magnetizations of the qubits as a function of a number of cycles.

11. The system of claim 10, wherein the characterization component evaluates the number of cycles at each execution iteration, and performs a next execution iteration until a defined fraction of the quantum device is characterized.

12. A computer-implemented method, comprising:
characterizing, by a system operatively coupled to a processor, qubits of a quantum device, wherein characterizing qubits of the quantum device comprises:
executing, on the quantum device, quantum circuits with many-body localization (MBL) in parallel to cover a topology of the quantum device.

13. The computer-implemented method of claim 12, further comprising:
determining, by the system, scores of the qubits of the quantum device based on the characterizing of the quantum device.

14. The computer-implemented method of claim 13, further comprising:
truncating, by the system, the topology of the quantum device by removing one or more qubits or edges based on the scores of the qubits to obtain a truncated topology.

15. The computer-implemented method of claim 12, further comprising:
executing, by the system, the quantum circuits with MBL with readout error mitigation to produce circuit execution data; and
extracting, by the system, two-qubit error rates from the circuit execution data and an error model.

16. The computer-implemented method of claim 14, further comprising:
obtaining, by the system, one or more sub-graphs of the truncated topology that are isomorphic to a target quantum circuit; and
scoring, by the system, the one or more sub-graphs based on the characterizing of the quantum device or calibration data of the quantum device.

17. The computer-implemented method of claim 14, further comprising:
iteratively executing, by the system, the quantum circuits with MLB on the quantum device until a termination criterion is satisfied for the qubits of the quantum device.

18. The computer-implemented method of claim 15, further comprising:
extracting, by the system, the circuit execution data based on a number of visible cycles per qubit or a decay rate.

19. A computer program product to assess quantum device quality, the computer program product comprising a computer readable storage medium having program instructions embodied therewith, the program instructions executable by a processor to cause the processor to:
characterize, by the processor, qubits of a quantum device, wherein characterizing qubits of the quantum device comprises:
executing, on the quantum device, quantum circuits with many-body localization (MBL) in parallel to cover a topology of the quantum device.

20. The computer program product of claim 19, wherein the program instructions are further executable by the processor to cause the processor to:
execute, by the processor, the quantum circuits with MBL with readout error mitigation to produce circuit execution data; and
extract, by the processor, two-qubit error rates from the circuit execution data and an error model.
